(19) United States
(12) Patent Application Publication
(10) Pub. No.: US 2009/0239488 A1
(43) Pub. Date: Sep. 24, 2009

(54) INFORMATION PROCESSING APPARATUS

(75) Inventor: Hajime Gushiken, Fussa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/257,160

(22) Filed: Oct. 23, 2008

(30) Foreign Application Priority Data
Mar. 19, 2008 (JP) 2008-072110

(51) Int. Cl. H04B 1/08; H04B 7/08

(52) U.S. Cl. 455/132; 455/347

(57) ABSTRACT

According to an aspect of the present invention, an information processing apparatus includes: a first casing that has at least an upper face, a side face and a front face; a second casing that includes a display device and that is connected to the first casing so as to be swingable between a first state and a second state, the first state where the second casing covers the upper face, the second state where the upper face is exposed; a third casing swingably connected to the second casing irrespectively of the second casing; and an antenna provided in the third casing. The third casing surrounds the upper face, the side face and the front face together with the second casing when the second casing is in the first state.

### CROSS-REFERENCE TO RELATED APPLICATIONS

This application is based upon and claims the benefit of priority from Japanese Patent Application No. 2008-072110, filed on Mar. 19, 2008, the entire contents of which are incorporated herein by reference.

### BACKGROUND

1. Field

An aspect of the present invention relates to an information processing apparatus mounting an antenna thereon and more particularly to an information processing apparatus capable of improving a receiving sensitivity of an antenna in use and storage of the apparatus.

2. Description of the Related Art

In recent years, according to a development of radio communication technology, a user can access to an internet away from home through a radio communication module mounted on a portable telephone or a computer. In a radio communication, a receiving sensitivity is varied depending on a radio field intensity or a receiving situation. Moreover, an angle of an antenna greatly influences the receiving sensitivity.

JP-A-2000-341018 discloses a portable information terminal having a built-in or external radio equipment in which a cover of the radio equipment is configured to have an opening/closing structure and the cover includes an antenna in such a manner that the cover can be closed to enhance a portability in non-use and an angle of the cover can be freely varied depending on a situation of a radio wave in use. Consequently, the portability can be enhanced and the angle can be freely varied to obtain an optimum sensitivity depending on the situation of the radio wave in use.

In the method, however, the angle of the antenna can be regulated in use and the antenna is accommodated in a body in storage (not in use). For this reason, it is impossible to fully exhibit an original characteristic of the antenna. In an information processing apparatus such as a personal computer of a notebook type, particularly, a radio communication may be carried out in such a storing state that a display unit provided with the antenna is closed. Also in this case, it is desirable to reduce a deterioration in the characteristic of the antenna.

### BRIEF DESCRIPTION OF THE SEVERAL VIEWS OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 is an exemplary perspective view showing an appearance of a computer according to a first embodiment of the invention;

FIG. 2 is an exemplary block diagram showing a configuration of the computer according to the first embodiment;

FIG. 3 is an exemplary view showing the computer viewed from a side according to the first embodiment;

FIG. 4 is an exemplary view showing the computer viewed from a front according to the first embodiment;

FIG. 5 is an exemplary perspective view showing an appearance of a computer according to a second embodiment of the invention; and

FIG. 6 is an exemplary block diagram showing a configuration of the computer according to the second embodiment.

### DETAILED DESCRIPTION

Various embodiments according to the present invention will be described hereinafter with reference to the accompanying drawings. In general, according to one embodiment of the present invention, there is provided an information processing apparatus including: a first casing that has at least an upper face, a side face and a front face; a second casing that includes a display device and that is connected to the first casing so as to be swingable between a first state and a second state, the first state where the second casing covers the upper face, the second state where the upper face is exposed; a third casing swingably connected to the second casing irrespectively of the second casing; and an antenna provided in the third casing; wherein the third casing surrounds the upper face, the side face and the front face together with the second casing when the second casing is in the first state.

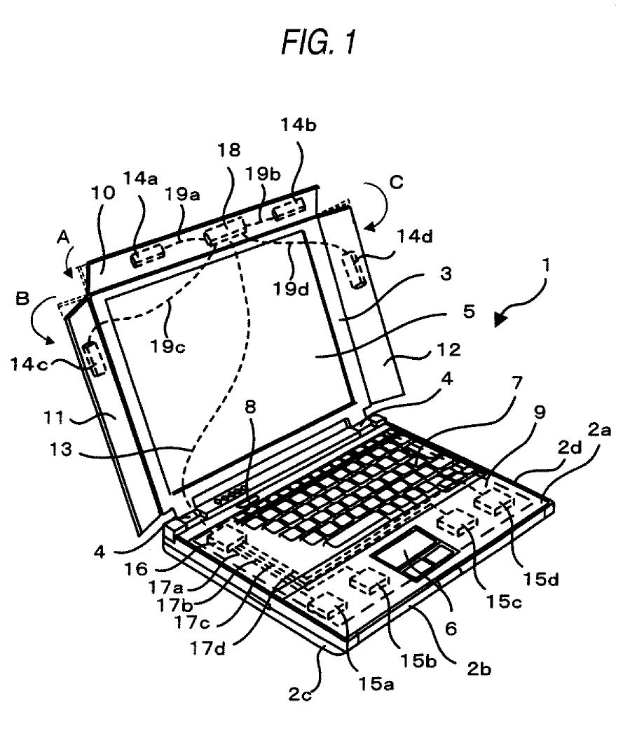

Embodiments according to the invention will be described below with reference to the drawings. In the embodiment, description will be given by taking a computer 1 of a notebook type as an example of an information processing apparatus. FIG. 1 is a perspective view showing an appearance of the computer according to the first embodiment of the invention.

The computer 1 includes a base unit 2, and a display unit 3 is swingably attached to the base unit 2 through a hinge portion 4. The base unit 2 has an upper face 2a, a front face 2b, a first side face 2c and a second side face 2d.

The display unit 3 is swingable between an opening position in which the upper face 2a of the base unit 2 is opened and a closing position in which the upper face 2a of the base unit 2 is covered. A display device configured of a Liquid Crystal Display (LCD) 5 is incorporated into the display unit 3. A touch pad 6 and a keyboard 7 are attached to the upper face 2a of the base unit 2, and the upper face 2a is also provided with a power switch 8 for turning ON/OFF a power supply of the computer 1.

The display unit 3 is provided with antenna casings 10, 11 and 12 which can be swung irrespectively of the display unit 3. The antenna casing 10 is swingable between a position in which the display unit 3 covers the base unit 2 and an opening position as shown in an arrow A. The antenna casing 11 is swingable between a position in which the antenna casing 11 is almost parallel with the display unit 3 and a position in which the antenna casing 11 is almost perpendicular to the display unit 3 as shown in an arrow B. The antenna casing 12 is swingable between a position in which the antenna casing 12 is almost parallel with the display unit 3 and a position in which the antenna casing 12 is almost perpendicular to the display unit 3 as shown in an arrow C.

The antenna casings 10, 11 and 12 can be swung irrespectively of the display unit 3, respectively. Therefore, it is possible to regulate positions of the antenna casings 10, 11 and 12 and angles formed with respect to the display unit 3. By regulating the positions and angles of the antenna casings 10, 11 and 12, it is possible to improve a receiving sensitivity.

A first antenna 14a and a second antenna 14b which serve to carry out a radio communication are accommodated in the antenna casing 10. A third antenna 14c is accommodated in the antenna casing 11, and a fourth antenna 14d is accommodated in the antenna casing 12. In addition to the configuration shown in FIG. 1, the first antenna 14a, the second antenna 14b, the third antenna 14c and the fourth antenna 14d can be provided in optional positions of the antenna casings 10, 11 and 12, respectively.

A circuit board 9 mounting a plurality of electronic components is accommodated in the base unit 2, and a plurality of radio communication modules 15 is mounted on the circuit board 9.

The first antenna 14a is a transmitting/receiving antenna to be used by a first radio communication module 15a. The first antenna 14a is configured in such a manner that a resonance frequency band thereof includes a frequency band for the first radio communication module 15a.

The second antenna 14b is a transmitting/receiving antenna to be used by a second radio communication module 15b. The second antenna 14b is configured in such a manner that a resonance frequency band thereof includes a frequency band for the second radio communication module 15b.

The third antenna 14c is a transmitting/receiving antenna to be used by a third radio communication module 15c. The third antenna 14c is configured in such a manner that a resonance frequency band thereof includes a frequency band for the third radio communication module 15c.

The fourth antenna 14d is a transmitting/receiving antenna to be used by a fourth radio communication module 15d. The fourth antenna 14d is configured in such a manner that a resonance frequency band thereof includes a frequency band for the fourth radio communication module 15d.

The circuit board 9 is provided with a first mixer/distributor 16. Each radio communication module 15 and the first mixer/distributor 16 are connected to each other through a cable. The first radio communication module 15a and the first mixer/distributor 16 are connected to each other through a cable 17a. The second radio communication module 15b and the first mixer/distributor 16 are connected to each other through a cable 17b. The third radio communication module 15c and the first mixer/distributor 16 are connected to each other through a cable 17c. The fourth radio communication module 15d and the first mixer/distributor 16 are connected to each other through a cable 17d.

The antenna casing 10 is provided with a second mixer/distributor 18. The first mixer/distributor 16 and the second mixer/distributor 18 are connected to each other through a coaxial cable 13. The coaxial cable 13 is led from the base unit 2 to the display unit 3 via an opening provided in the hinge portion 4. The second mixer/distributor 18 is connected to each of the antennas provided in the antenna casings 10, 11 and 12 through a cable.

The second mixer/distributor 18 and the first antenna 14a are connected to each other through a cable 19a. The second mixer/distributor 18 and the second antenna 14b are connected to each other through a cable 19b. The second mixer/distributor 18 and the third antenna 14c are connected to each other through a cable 19c. The second mixer/distributor 18 and the fourth antenna 14d are connected to each other through a cable 19d.

Signals received through the first to fourth antennas 14a to 14d are synthesized in the second mixer/distributor 18 and a signal thus obtained is transmitted from the second mixer/distributor 18 to the first mixer/distributor 16 through the coaxial cable 13. The first mixer/distributor 16 distributes the signal synthesized in the second mixer/distributor 18 and transmits the signal to the radio communication modules 15a, 15b, 15c and 15d corresponding to the antennas 14a, 14b, 14c and 14d.

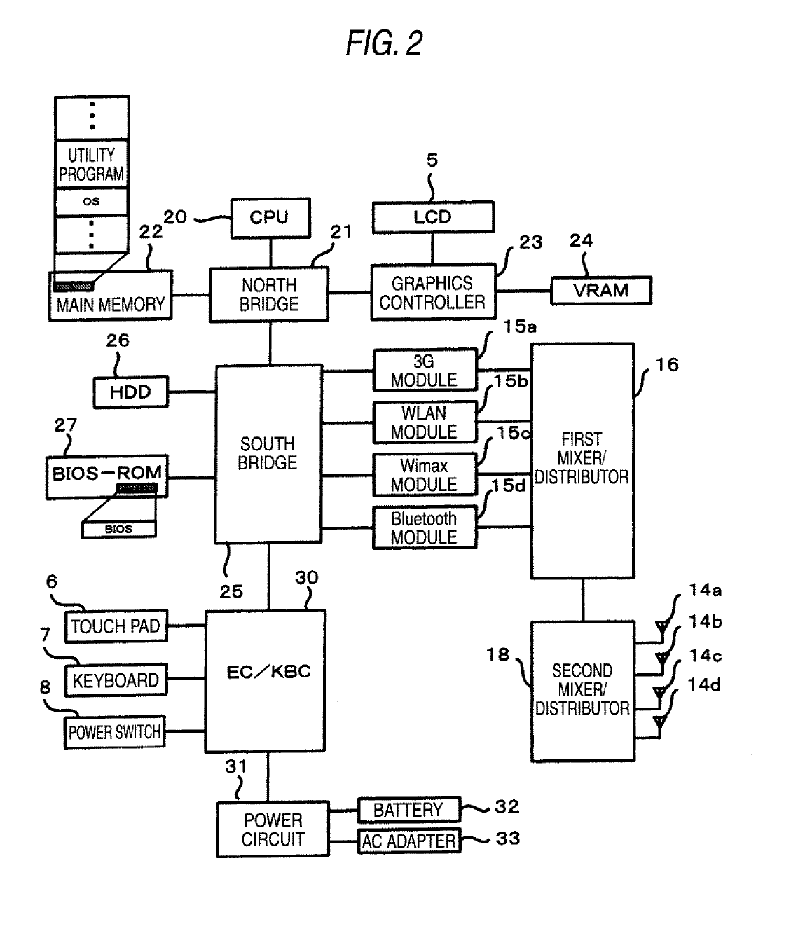

FIG. 2 is a block diagram showing a configuration of the computer according to the first embodiment of the invention.

The computer 1 is provided with a CPU 20, a north bridge 21, a main memory (RAM) 22, a graphics controller 23, a VRAM 24, a south bridge 25, a hard disk drive (HDD) 26, a BIOS-ROM 27, and an embedded controller/keyboard controller IC (EC/KBC) 30.

The CPU 20 is a processor for controlling an operation of each component in the computer 1. The CPU 20 executes an operating system and various application programs and utility programs which are loaded onto the main memory (RAM) 22 from the HDD 26. The main memory (RAM) 22 is also used for storing various data buffers. Moreover, the CPU 20 also executes Basic Input Output System (BIOS) program stored in the BIOS-ROM 27. The BIOS is a program for a hardware control.

The north bridge 21 is a bridge device for connecting a local bus of the CPU 20 to the south bridge 25. Moreover, the north bridge 21 also has a function for executing a communication with the graphics controller 23 through a PCI Express bus. Furthermore, the north bridge 21 also includes a memory controller for controlling the main memory (RAM) 22.

The graphics controller 23 is a display controller for controlling contents to be displayed on the LCD 5 used as a display monitor of the computer 1 and a brightness. The graphics controller 23 transmits, to the LCD 5, a video signal corresponding to display data written to the video memory (VRAM) 24 in accordance with the OS or the application program.

The HDD 26, the first radio communication module 15a, the second radio communication module 15b, the third radio communication module 15c and the fourth radio communication module 15d are connected to the south bridge 25. The HDD 26 stores the OS and various application programs.

In the embodiment, description will be given by taking, as an example, the case in which a 3G module, a Wireless Local Area Network (WLAN) module, a Worldwide Interoperability for Microwave Access (WiMAX) module and a Bluetooth (registered trademark) module are used as the first radio communication module 15a, the second radio communication module 15b, the third radio communication module 15c and the fourth radio communication module 15d, respectively. The 3G module 15a, the WLAN module 15b, the WiMAX module 15c and the Bluetooth module 15d are connected to the south bridge 25 through a USB bus. As shown in FIG. 1, moreover, each of the radio communication modules 15a, 15b, 15c and 15d is connected to the first mixer/distributor 16. The first mixer/distributor 16 and the second mixer/distributor 18 are connected to each other through the coaxial cable 13. Therefore, it is also possible to cope with a design change by varying only an arrangement of the antenna 14 on the display unit 3 side.

The embedded controller/keyboard controller (EC/KBC) 30 is a one-chip microcomputer in which an embedded controller for a power management and a keyboard controller for controlling the touch pad 6 and the keyboard 7 are integrated. The EC/KBC 30 executes a processing for turning ON/OFF the computer 1 in response to a manipulation of the power switch 8 through a user in cooperation with a power controller 31. The power controller 31 supplies a power to each component in the computer 1 by using a power fed from a battery 32 provided in the computer 1 or a power fed from an outside through an AC adapter 33.

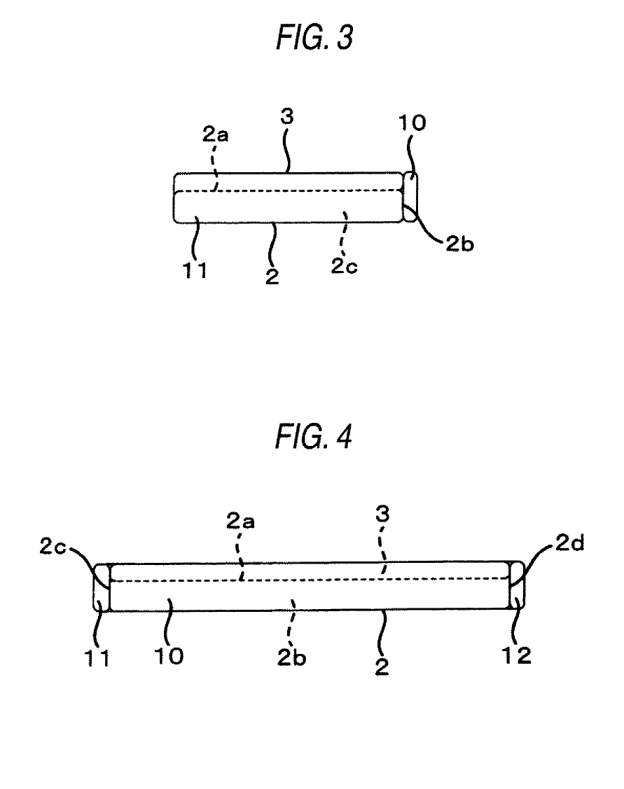

FIG. 3 is a view showing a side face of the computer according to the first embodiment of the invention. FIG. 4 is a view showing a front face of the computer according to the first embodiment of the invention. As shown in FIGS. 3 and 4, the upper face 2a of the base unit 2 is covered with the display unit 3 in a state in which the display unit 3 is closed as shown in FIGS. 3 and 4. When the antenna casings 10, 11 and 12 are folded up, moreover, the upper face 2a, the front face 2b, the first side face 2c and the second side face 2d of the base unit 2 are covered.

In the embodiment, since the antennas 14 are provided in the antenna casings 10, 11 and 12, therefore, in storage of the computer 1 in which the display unit 3 is closed, the antennas 14 are positioned on an outside of the base unit 2 and the display unit 3. The antenna casings 10, 11 and 12 face the outside. Therefore, a smaller number of components shield a radio wave transmitted/received to/from the antennas 14. As a result, also in a state in which the user brings the computer 1 into a suspended condition to close the display unit 3, for example, it is possible to improve the receiving sensitivity of the antenna, thereby preventing a radio communicating performance from being deteriorated.

By setting the positions and angles of the antenna casings 10, 11 and 12 provided with the antennas 14 irrespective of an opening and inclining angle of the display unit 3, furthermore, it is possible to reduce the deterioration in the radio communicating performance.

According to the embodiment of the invention, it is possible to provide an information processing apparatus capable of improving the receiving sensitivity of the antenna in use and in storage (not in use) of the apparatus.

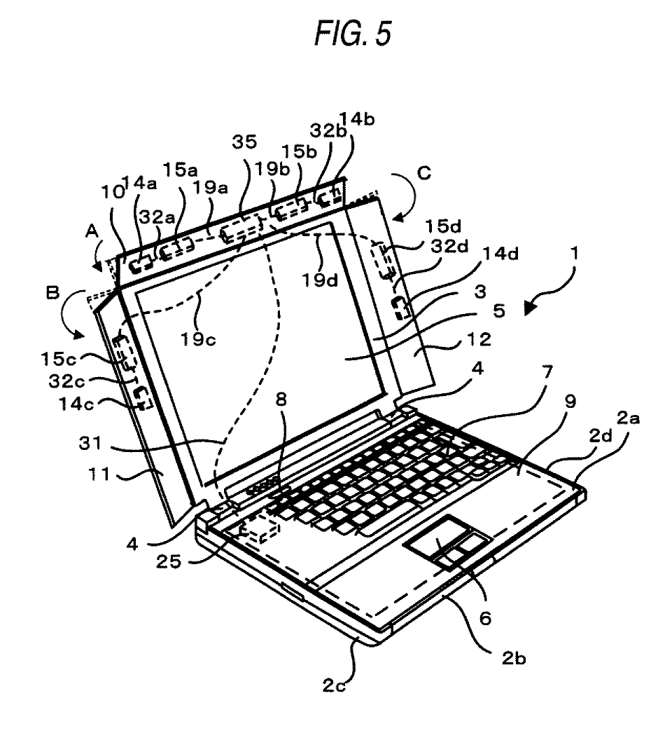

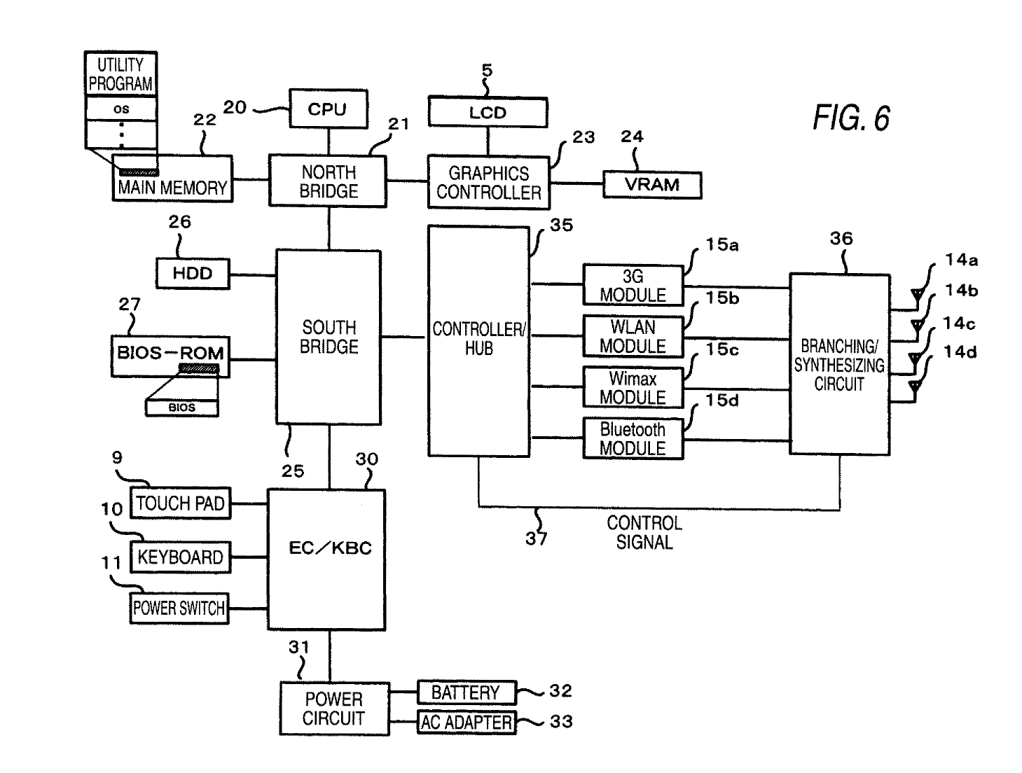

Next, the second embodiment according to the invention will be described with reference to FIGS. 5 and 6. In the following description, common configurations to those in the first embodiment have the same reference numerals and repetitive description will be omitted. FIG. 5 is a perspective view showing an appearance of a computer according to the second embodiment of the invention. FIG. 6 is a block diagram showing a configuration of the computer according to the second embodiment of the invention.

A display unit 3 is provided with antenna casings 10, 11 and 12 which can be swung irrespectively of the display unit 3. A first antenna 14a, a second antenna 14b, a first radio communication module 15a and a second radio communication module 15b which serve to carry out a radio communication are accommodated in the antenna casing 10. A third antenna 14c and a third radio communication module 15c are accommodated in the antenna casing 11. A fourth antenna 14d and a fourth radio communication module 15d are accommodated in the antenna casing 12. In addition to the configuration shown in FIG. 5, it is possible to provide the first antenna 14a, the second antenna 14b, the third antenna 14c, the fourth antenna 14d, the first radio communication module 15a, the second radio communication module 15b, the third radio communication module 15c and the fourth radio communication module 15d in optional positions of the antenna casings 10, 11 and 12, respectively.

A circuit board 9 mounting a plurality of electronic components is accommodated in a base unit 2, and a south bridge 25 mounted on the circuit board 9 and a controller/hub 35 mounted on the display unit 3 are connected to each other through a cable 31. The cable 31 is led from the base unit 2 to the display unit 3 through an opening provided in a hinge portion 4.

The controller/hub 35 mounted on the display unit 3 and each radio communication module 15 are connected to each other through a cable 32. The first radio communication module 15a and the controller/hub 35 are connected to each other through a cable 19a. The second radio communication module 15b and the controller/hub 35 are connected to each other through a cable 19b. The third radio communication module 15c and the controller/hub 35 are connected to each other through a cable 19c. The fourth radio communication module 15d and the controller/hub 35 are connected to each other through a cable 19d.

The controller/hub 35 carries out a power control of the radio communication modules 15a, 15b, 15c and 15d and an ON/OFF control of an RF output.

The radio communication modules 15a, 15b, 15c and 15d and the antennas 14a, 14b, 14c and 14d are connected to each other through cables 32a, 32b, 32c and 32d, respectively.

A branching/synthesizing circuit 36 is provided between the radio communication modules 15a, 15b, 15c and 15d and the antennas 14a, 14b, 14c and 14d as shown in FIG. 6. But for convenience of the description, the branching/synthesizing circuit 36 is not shown in FIG. 5. The branching/synthesizing circuit 36 branches and/or synthesizes radio waves received and/or to be transmitted through the antennas 14a, 14b, 14c and 14d.

A signal conductor 37 is provided between the controller/hub 35 and the branching/synthesizing circuit 36, and the controller/hub 35 transmits a control signal for controlling the branching/synthesizing circuit 36. By transmitting the control signal from the controller/hub 35, it is also possible to ON/OFF control the radio communication modules 15a, 15b, 15c and 15d individually, to carry out a communication with only a specific one of the radio communication modules and to turn ON/OFF the radio communication modules 15a, 15b, 15c and 15d at a time.

Also in the second embodiment, since the antennas 14 are provided in the antenna casings 10, 11 and 12, therefore, in storage of a computer 1 in which the display unit 3 is closed, the antennas 14 are positioned on an outside of the base unit 2 and the display unit 3. The antenna casings 10, 11 and 12 face the outside. Therefore, a smaller number of components shield a radio wave transmitted/received to/from the antennas 14. As a result, also in a state in which the display unit 3 is closed, for example, a suspended condition of the computer 1, it is possible to improve the receiving sensitivity of the antenna, thereby preventing a radio communicating performance from being deteriorated.

By setting the positions and angles of the antenna casings 10, 11 and 12 provided with the antennas 14 irrespective of an opening and inclining angle of the display unit 3, furthermore, it is possible to reduce the deterioration in the radio communicating performance.

As described above, according to the embodiments of the invention, it is possible to provide an information processing apparatus capable of improving a receiving sensitivity of an antenna in use and storage of the apparatus.

The invention is not restricted to the embodiments but various changes can be made without departing from the scope thereof.

What is claimed is:

1. An information processing apparatus comprising:
a first casing that has at least an upper face, a side face and a front face;
a second casing that includes a display device and that is connected to the first casing so as to be swingable between a first state and a second state, the first state where the second casing covers the upper face, the second state where the upper face is exposed;
a third casing swingably connected to the second casing irrespectively of the second casing; and
an antenna provided in the third casing;
wherein the third casing surrounds the upper face, the side face and the front face together with the second casing when the second casing is in the first state.

2. The apparatus according to claim 1,
wherein the antenna includes a plurality of antennas,
the apparatus further comprising:
a substrate provided in the first casing;
a plurality of radio communication modules provided on the substrate corresponding to each of the antennas;
a first mixer/distributor provided on the substrate and connected to the radio communication modules;
a second mixer/distributor provided in the third casing and connected to the antennas; and
a cable that connects the first mixer/distributor to the second mixer/distributor.

3. The apparatus according to claim 1,
wherein the antenna includes a plurality of antennas,
the apparatus further comprising:
a first controller;
a substrate provided in the first casing and the first controller is mounted thereon;
a plurality of radio communication modules provided in the third casing corresponding to each of the antennas;
a second controller provided in the third casing and the radio communication modules are connected thereon; and
a cable that connects the first controller to the second controller.

4. The apparatus according to claim 3, further comprising:
a branching/synthesizing circuit provided in the third casing, connected to the radio communication modules, and configured to branch and/or synthesize radio waves received and/or to be transmitted through the antennas; and
a signal conductor through which a control signal is transmitted from the second controller to the branching/synthesizing circuit.
